(19) United States
(12) Patent Application Publication
(10) Pub. No.: US 2023/0133181 A1
(43) Pub. Date: May 4, 2023

(54) POST-TENSION TENDON TAIL CUTTING TOOL

(71) Applicant: Odom Tool, LLC, La Marque, TX (US)

(72) Inventor: David Kyle Odom, La Marque, TX (US)

(73) Assignee: Odom Tool, LLC, La Marque, TX (US)

(21) Appl. No.: 17/979,428

(22) Filed: Nov. 2, 2022

Related U.S. Application Data
(60) Provisional application No. 63/263,459, filed on Nov. 3, 2021.

(51) Int. Cl. B23D 19/08; B23D 29/00

(52) U.S. Cl. CPC B23D 19/08; B23D 29/002

(57) ABSTRACT

A blade housing includes: a rotary blade and an opening, in which the blade housing is configured to be affixed to a blade housing connector, and in which when a motor rotates the blade housing connector, the rotary blade rotates to cut a post-tension (PT) tendon tail inside a stressing pocket, in which the blade housing is sized to fit within the stressing pocket, in which the opening of the blade housing is sized to allow the PT tendon tail to be extended through the blade housing.

### CROSS-REFERENCE TO RELATED APPLICATIONS

This application claims priority and benefits under 35 USC § 119 to U.S. Provisional Application No. 63/263,459 filed on Nov. 3, 2021. U.S. Provisional Application No. 63/263,459 is hereby incorporated by reference in its entirety.

### BACKGROUND

Post-tensioned concrete is a variant of pre-stressed concrete where tendons (or cables) are tensioned after the surrounding concrete structure has been cast. The tendons witnessed today are often made of seven high-strength steel wires wound together, and at each end of the tendons, a post-tension (PT) anchor is positioned to secure the tendon and to distribute tensile force into the concrete structure by applying tension to the tendons. After applying tension (e.g., after stressing), portions of the tendons that extend out of stressing pockets are cut off. The stressing pockets are then filled with non-shrink grout for protection purposes (e.g., to prevent corrosion over time).

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1 shows a diagram of a PT tendon tail cutting tool in accordance with one or more embodiments of the invention.

FIG. 2.1 shows an isometric view of a blade housing in accordance with one or more embodiments of the invention.

FIG. 2.2 shows a side view of the blade housing in accordance with one or more embodiments of the invention.

FIG. 2.3 shows a top view of a bottom housing component in accordance with one or more embodiments of the invention.

FIG. 2.4 shows a top view of a rotary blade in accordance with one or more embodiments of the invention.

FIG. 2.5 shows a top view of a top housing component in accordance with one or more embodiments of the invention.

FIG. 3.1 shows an isometric view of a blade housing in accordance with one or more embodiments of the invention.

FIG. 3.2 shows a side view of the blade housing in accordance with one or more embodiments of the invention.

FIG. 3.3 shows a top view of the blade housing in accordance with one or more embodiments of the invention.

FIG. 4.1 shows a diagram of a PT tendon tail cutting tool in accordance with one or more embodiments of the invention.

FIG. 4.2 shows a top view of the PT tendon tail cutting tool in accordance with one or more embodiments of the invention.

FIG. 5 shows a diagram of a PT tendon tail cutting tool in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, to reinforce a concrete slab during concrete construction, tendons may be laid out before concrete is poured with enough length on either end to extend past sides (e.g., a right side, a left side, etc.) of the concrete slab. At this point, the tendons are not yet in tension. Once the concrete slab has been cast and set, stressing pockets (e.g., temporary recesses) are formed, in which some portions of the tendons (e.g., tendon tails) extend out of the stressing pockets. In order to reinforce the concrete slab, at each end of tendon tails, PT anchors may be positioned to secure the tendon tails and to distribute tensile force into the concrete slab while applying tension to the tendon tails. Using the stressing pockets, a stressing device may access to the PT anchors to stress (e.g., to pull) the tendon tails.

Once the tendon tails are stressed, PT tendon tails that are inside of the stressing pockets need to be cut off so that the stressing pockets may then be filled with a concrete cover for protection purposes. Typically, as a first option, a PT tendon tail may first be cut close to an outside of a stressing pocket using a conventional rotary device (e.g., a gas powered saw). The remaining portion of the PT tendon tail that is still protruding from the stressing pocket may then be (i) removed by burning the PT tendon tail end off with a torch (e.g., an oxygen torch) or (ii) cut using a rotary abrasive/cut-off saw, an angle grinder, or a shear cutting tool (e.g., a hydraulically operated pocket shear cutting tool, a battery powered pocket shear cutting tool, etc.). As a second option, the PT tendon tail may be cut off inside the stressing pocket using a torch or a shear cutting tool. However, both options (and other practices and apparatuses) have disadvantages, such as a requirement of a special permitting, increased safety risks, a potential damage to a PT tendon remaining in the concrete slab, inability to perform multi-directional abrasive cut, inability to cut a required length of a PT tendon tail, a costly operation, a requirement of multiple people to operate, or retraction of a PT tendon into the concrete slab.

To address one or more of the aforementioned disadvantages (e.g., issues), embodiments of the invention provide a PT tendon tail cutting tool as an alternative to current practices and apparatus used in concrete construction where PT tendons are used to reinforce concrete slabs. More specifically, embodiments of the invention describe a handheld, lightweight, and portable form factor PT tendon tail cutting tool that does not cause the aforementioned issues. This advantageously makes transportation, usability, and operation of the PT tendon tail cutting tool practical and easier for a customer. This also advantageously allow cutting a PT tendon tail in one step rather than in multiple steps.

The following describes various embodiments of the invention.

Apart from the aforementioned use case (e.g., the stressing pocket PT tendon case), PT tendons may be considered in different use cases, for example (but not limited to): a slab-on-a-grade PT tendon case, an encapsulated PT tendon case, etc. While the invention is described with respect to cutting a PT tendon tail inside a stressing pocket, the invention may be used for any PT tendon tail cutting case.

Before describing the PT tendon tail cutting tool and method of use, details of the generation of a PT tendon tail are described below.

As used herein, “PT tendons” are cables that extend through and reinforce post-tensioned concrete structures (e.g., slabs). Typically, a PT tendon is defined as an assembly of a sheathing component (e.g., a duct, an enclosure, etc.), a pre-stressing seven-wire strand, pre-stressing components (e.g., anchorages, couplers, etc.), and corrosion inhibiting grease or grout (e.g., PT coating) that fills voids inside of the sheathing component. A PT tendon may include one or more seven-wire strands. A duct may accommodate pre-stressing steel installation and provides an annular space for grouting. Further, a pre-stressing wire may be made of pre-stressing steel (e.g., high-strength steel) and may operate in conjunction with stress bars, stress back-up bars, or groups of such components.

As used herein, a “duct” includes any tube, pipe, conduit, or a combination thereof, that has one or more passageways through which a fluid or a gas can be conveyed. Examples of materials for a duct may include a cloth, a fabric, an extruded metal, a sheet metal, a polymer, or a combination thereof. A passageway of a duct may have any size and shape. The cross-section of a duct may be square, round, ovate, rectangular, or irregular. Further, a passageway of a duct may have a constant or changing cross-section, or a cross-section that changes over the length of the passageway.

As used herein, “grout” is a mixture of a cementitious materials and water (with or without mineral additives or admixtures) proportioned to produce a pumpable consistency without segregation of constituents injected into the duct to fill space around the pre-stressing steel.

Typically, in multi-strand applications, the duct and structural components (e.g., grout caps, grout vents, etc.) are often grouted to bond the strand to the concrete slab along its entire length. When the duct is fully grouted, the combined grout, duct, and tendons are called “bonded tendons”, in which the pre-stressing steel is bonded to the concrete and the pre-stressing steel is permanently prevented from moving (within the duct) relatively to the concrete slab. In mono-strand applications, the duct is not grouted (but greased to prevent corrosion over time) and the resulting combination of the duct, grease, and tendons are called “unbonded tendons”, in which the pre-stressing steel is prevented from bonding to the concrete and the pre-stressing steel is permanently free to move (within the duct) relative to the concrete. For this reason, pre-stressing force may be transferred to the concrete only through anchorages and/or deviators.

As used herein, a “post-tensioned concrete slab” is a form of pre-stressed concrete slab where tendons (e.g., PT tendons) are tensioned (to reinforce the concrete slab) after the surrounding concrete slab has been cast. Typically, construction of a post-tensioned concrete slab is similar to using reinforcing steel, except for the tensioning step (or process). The tendons may laid out (e.g., arranged, placed, etc.) before the concrete is poured with enough length on either end to extend past sides of the concrete slab. The tendons are arranged as indicated by a qualified operator and, in most cases, the tendons may be arranged in, for example (but not limited to): a banded-distributed layout (banded tendons are oriented in one direction and distributed tendons are oriented in the other direction), a banded-banded layout (banded in both directions), a distributed-distributed layout (distributed in both directions), a mixed layout (mixed banded and distributed in both directions), etc.

The aforementioned four options are deemed to provide equal strength capacity. The choice of layout is generally governed by constructability; however, in most cases, the preferred layout is the banded-distributed layout, in which a portion of the distributed tendons are placed and secured (using mechanical or non-mechanical mechanisms) in positon first, followed by the placement of the banded tendons. The rest of the distributed tendons are placed over the banded tendons. The constructability advantage of this layout is that the banded-distributed layout does not require interweaving of tendons in different directions, whereas most other tendon layouts require some interweaving.

From a design standpoint, one other advantage of the banded-distributed layout is that both directions may be designed with a maximum permissible tendon drape. In most cases, banded and distributed tendons do not cross at their high or low points, except the distributed tendons over tendon support components. In this manner, bulk of strands may be placed with a maximum allowable drape without having any interference from the tendons oriented in the perpendicular direction.

Tendon support components may be required to maintain a designated profile (e.g., a path) of a tendon from end to end (before and/or during concrete placement). Tendon support components may be, for example (but not limited to): support bars, chairs, slab bolsters, etc.

In the banded-distributed layout, for example, tendons that are arranged in the banded direction are grouped in a number of flat bundles and placed parallel to one another with a relatively small gap separating the constituent bundles. The tendons generate a narrow band, typically up to or slightly larger than 1.20 meter in width, following a hypothetical support line that connects a line of columns and/or walls in one direction. As yet another example, tendons that are arranged in the distributed direction are placed in bundles of one to four strands, spread over the entire width of a design strip with equal spacing between the constituent bundles and, typically, perpendicular to the banded tendons.

After the tendons are laid out using one of the tendon layouts (discussed above) and after the concrete is poured and set, portions of the tendons that extend past the concrete slab through inset cavities at the sides of the concrete slab are called as “stressing pockets”, and the portions of the tendons that extend out of the stressing pockets are called as “tails”. As used herein, a “stressing pocket” is a temporary recess (generated by a pocket former) between a stressing anchorage (or an intermediate anchorage) and the sides of the concrete slab to allow access for stressing. A stressing pocket is typically cylindrical or frusto-conical in shape and not very wide. More specifically, the stressing pocket may have a cross-section that is a constant or a changing cross-section, or a cross-section that changes over the length of the pocket. For example, the width of the pocket may be 3 inches (7.6 centimeters) at the edge of the concrete slab, and because of its frusto-conical shape, the width of the pocket may be 2.5 inches (6.35 centimeters) where a tail needs to be cut.

The aforementioned example is not intended to limit the scope of the invention and the frusto-conical shape may be configured to any required shape (e.g., an oblong) to allow an anchor access and/or a torch access when needed.

As used herein, an “anchorage” is a mechanical apparatus consisting of one or more components required to transfer post-tensioning force from pre-stressing steel to concrete. The components may be, for example (but not limited to): transition tubes, bearing plates, confinement steel, etc. A stressing anchorage may refer to an anchorage at one or both ends of a tendon that is used for stressing. Similarly, an intermediate anchorage may refer to an anchorage that is located at any point along the tendon. The intermediate anchorage may be used to stress only a portion of the tendon at, for example, a construction joint. The tendon may continuous or spliced at that location.

In order to reinforce the concrete slab, at each end of tendons, PT anchors may be positioned to secure the tendons and to distribute tensile force into the concrete slab while applying tension to the tendons. Using the stressing pocket, a stressing device may access to the PT anchor for force application and wedge seating operations. As used herein, a “PT anchor” is an anchor located within the concrete slab. In most cases, a PT anchor may be used for unbonded single strand tendons to transfer pre-stressing force to the concrete slab. The PT anchor may include a cavity (e.g., a tapered opening) designed to allow a strand passing through and to accommodate the seating of a wedge. Depending on an application, the anchor may be encapsulated, for example, with a plastic enclosure to prevent corrosion over time.

As used herein, a “wedge” is a tapered component that is made of high-strength, heat-treated steel with serrations (e.g., teeth) that penetrate pre-stressing steel while applying pre-stressing force (e.g., jacking force). In this manner, the wedge stops backward movement of the tendon towards the concrete slab and keeps the tendon in tension. Depending on an application, for example, some anchorages may use two-part wedges or three-part wedges.

In order to apply tension to a tendon, the stressing device (consisting of a hydraulic jack and gauge(s)) may be attached to the tendon, and the tendon may be stressed or pulled by the stressing device. This results in a tail (discussed above) that protrudes from an edge of the concrete slab. While in tension, the pulled tendon is secured (via one or more PT anchors at both ends) to the concrete slab, in which the PT anchors maintain the tendon (and the concrete between the PT anchors) in tension after the stressing device is released from the tendon.

Similar to the tendon arrangement process discussed above, stressing of a PT tendon may be performed only by a qualified operator to minimize tensioning related issues and to minimize engineering-intensive efforts. For example, after tensioning a 50-foot strand, the tendons may stretch about 4 inches to apply 33,000 pounds of load. In order to minimize tensioning related issues before applying 33,000 pounds of load, a qualified operator may need to perform and/or manage the stressing process.

After tensioning and securing, the tail inside of the stressing pocket (e.g., the restricted area) needs to be cut off so that (i) the stressing pocket can be filled with non-shrink grout (e.g., a concrete cover) or (ii) a grease cap can be fitted inside the stressing pocket for protection purposes. In order to cut off the tail inside of the stressing pocket, a PT tendon tail cutting tool (e.g., apparatus) may be used. While the invention is described with respect to PT tendons, the invention may be extended to cover any other cable, for example (but not limited to): PT barrier cables, pre-stressing steel cables, etc.

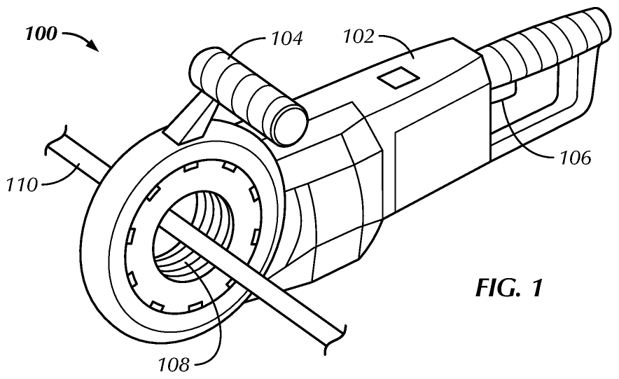

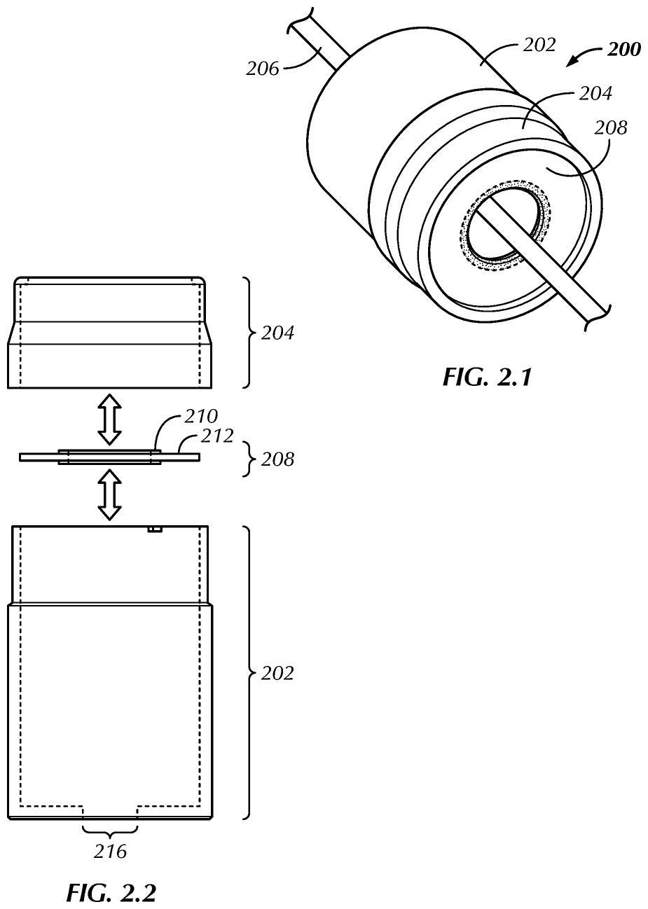

Turning now to FIG. 1, FIG. 1 shows a diagram of a PT tendon tail cutting tool (100) in accordance with one or more embodiments of the invention. The PT tendon tail cutting tool (100) includes a body (102), a handle (104), an initiation mechanism (106), a blade housing connector (108), and an internal electric motor (not shown). The PT tendon tail cutting tool (100) may include additional, fewer, and/or different components without departing from the scope of the invention. Each component illustrated in FIG. 1 is described below.

In an embodiment of the invention shown in FIG. 1, the body (102) may be a mechanical structure that enables the handle (104), the initiation mechanism (106), the blade housing connector (108), and the internal electric motor (also referred to herein as an “electric motor”) to be disposed within or to be affixed to the body (102).

In one or more embodiments, while disposing, the electric motor and the blade housing connector (108) may be affixed within the body (102) via standard mechanical mechanisms (e.g., bolts, screws, nuts, studs, etc.). Other mechanical or non-mechanical (e.g., glue, an adhesive tape, etc.) mechanisms for affixing the electric motor and the blade housing connector (108) within the body (102) may be used without departing from the scope of the invention.

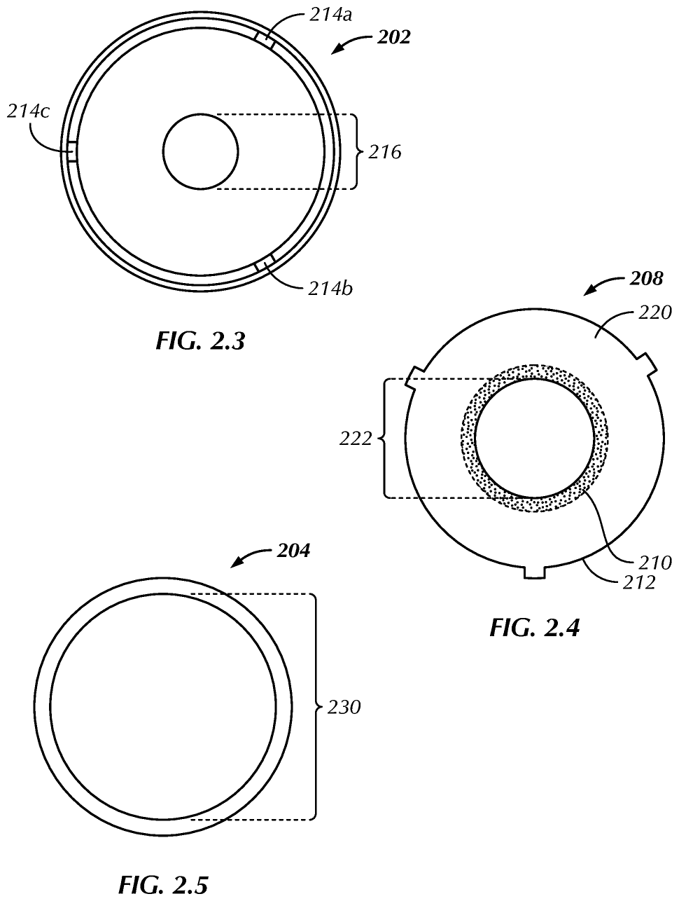

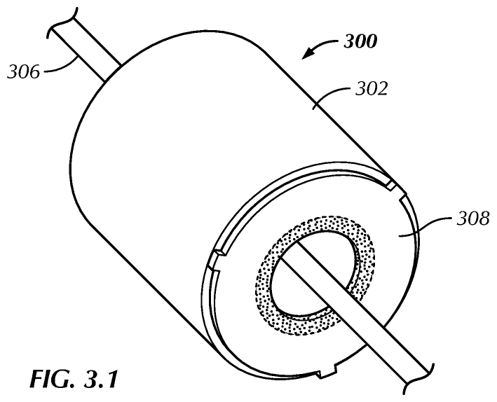

In one or more embodiments, a blank space (or a cavity) within the body (102), where the blade housing connector (108) is located, may have a functionality to host different types of standard blade housings (e.g., a 45 millimeter (mm) wide blade housing (e.g., 200, FIG. 2.1), a 50 mm wide blade housing, etc.). The blade housing connector (108) may also have a functionality to host custom designed blade housings. Both standard (e.g., off-the-shelf) and custom designed blade housings may be pre-integrated into the blade housing connector (108) before shipping the PT tendon tail cutting tool (100) to a customer site (e.g., a customer location, a customer facility, etc.).

Further, because the blade housing (e.g., 200, FIG. 2.1) is a modular component, (i) a customer (e.g., a qualified customer, a qualified operator, etc.) may affix (e.g., integrate) the blade housing (e.g., 200, FIG. 2.1) to the blade housing connector (108) at the customer site, or (ii) the customer may remove the pre-integrated blade housing (e.g., 200, FIG. 2.1) from the blade housing connector (108) and affix a different type of blade housing without worrying about resource (e.g., engineering, manufacturing, procurement, etc.) intensive efforts. Additional details of the blade housing are described below in reference to FIGS. 2.1-3.3.

In one or more embodiments, the handle (104) may have a functionality to improve accuracy, usability, and maneuverability of the PT tendon tail cutting tool (100) for a customer. For this reason, the handle (104) may be a non-slip, anti-vibration handle, and may act as a cushioning barrier (e.g., an isolator) between the blade housing (e.g., 200, FIG. 2.1) and the handle (104). As being an anti-vibration handle, the handle (104) may reduce vibration up to 70% because of its textured rubber (or plastic grip) damper.

In one or more embodiments, the handle (104) may also have a functionality to act as a mechanical hard-stop component. In this manner, the handle (104) may provide structural support to the body (102) while, for example, cutting a PT tendon tail.

In one or more embodiments, the handle (104) may be affixed to the body (102) via the standard mechanical mechanisms. Other mechanical or non-mechanical mechanisms for affixing the handle (104) to the body (1402) may be used without departing from the scope of the invention.

Those skilled in the art will appreciate that while the handle (104) is shown as having a particular size, shape, and placement, the handle (104) may have any size, shape, and placement (while still providing the same functionalities) without departing from the scope of the invention.

In one or more embodiments, the body (102) may include an auxiliary (e.g., a secondary) handle to improve accuracy and stabilization of the PT tendon tail cutting tool (100) so that the PT tendon tail cutting tool (100) may be operated more safely. The auxiliary handle may be affixed to any side (e.g., a rear side, a left side, etc.) of the body (102) using standard mechanical mechanisms. Other mechanical or non-mechanical mechanisms for affixing the auxiliary handle to the body (102) may be used without departing from the scope of the invention. For example, the auxiliary handle may be affixed to right side and/or left side of the body (102) such that the PT tendon tail cutting tool (100) may be used by right- and/or left-handed customers.

In one or more embodiments, the initiation mechanism (106) may be any suitable mechanism (e.g., a releasable trigger, an on/off switch, an on/off button, etc.) that initiates providing power to the electric motor to operate the PT tendon tail cutting tool (100) for cutting a PT tendon tail (110) (described above). In one or more embodiments, the initiation mechanism (106) may have a functionality to provide an overload protection for safety purposes. For example, if the PT tendon tail cutting tool (100) needs to operate in an environment with harsh conditions, the overload protection may prevent overheating of the PT tendon tail cutting tool (100) by cutting of power to the electric motor until the electric motor cooled down.

In one or more embodiments, the initiation mechanism (106) may also have a functionality to provide a soft-start in order to make the PT tendon tail cutting tool (100) easier to handle on start-up. With this functionality, for example, the electric motor may gradually build up to its maximum speed so that the electric motor may not suddenly start (e.g., kick) after the electric motor is turned on.

Further, the initiation mechanism (106) may act as a paddle-operated no-volt release switch to provide an additional security measure before providing power to the electric motor. For example, as being a no-volt release switch, the initiation mechanism (106) may feature a safety lock-off to prevent a customer from accidentally switching the PT tendon tail cutting tool (100) on before the customer is ready to use the PT tendon tail cutting tool (100). The customer may need to push the switch halfway so that the PT tendon tail cutting tool (100) only operates when the customer is applying pressure, or may need to switch further along to lock the switch in position.

In one or more embodiments, the initiation mechanism (106) may also act as a manually operated electromechanical interface, in which the interface (directly or by way of a control circuit) provides a control of the electric motor. In order to provide the control of the electric motor, the interface may include electromechanical and/or solid-state electronic components for turning the electric motor on or off, and/or changing a rotational speed of the blade housing connector (108).

As used herein, an “electric motor” is a component that converts electrical energy into mechanical energy, usually in the form of rotational motion. Said another way, an electric motor is a device that uses electric power to generate motive power. An electric motor may be electrically powered either by a battery pack or by being plugged into a power source (e.g., the power supply component, discussed above) using, for example, a power cord (e.g., a power wire, a power cable, etc.). Electric motors may be in many different forms depending on the type of current flow they use, the design of their coils (e.g., windings), and how they generate a magnetic field.

As used herein, a “cable” includes any cable, conduit, or line that carries one or more conductors and that is flexible over at least a portion of its length. A cable may include a connector portion, such as a plug, at one or more of its ends.

In one or more embodiments, the blade housing connector (108) may be a mechanical structure that enables the blade housing (e.g., 200, FIG. 2.1) to be disposed within or to be affixed to the blade housing connector (108). In this manner, blade housing (e.g., 200, FIG. 2.1) may be coaxially installed on the blade housing connector (108). In one or more embodiments, while disposing, the blade housing (e.g., 200, FIG. 2.1) may be releasably secured within the blade housing connector (108) via standard mechanical mechanisms. Other mechanical or non-mechanical mechanisms for releasably securing the blade housing (e.g., 200, FIG. 2.1) within the blade housing connector (108) may be used without departing from the scope of the invention.

In one or more embodiments, the blade housing connector (108) may include a connection interface, in which the connection interface of the blade housing connector (108) refers to a portion of the blade housing connector (108) that can be paired with (e.g., connected to) another component (e.g., the blade housing (e.g., 200, FIG. 2.1)). In one or more embodiments, the connection interface of the blade housing connector (108) includes mechanical connection components such that, when secured, (i) the blade housing (e.g., 200, FIG. 2.1) can rotate at the same speed as the blade housing connector (108) and (ii) the blade housing (e.g., 200, FIG. 2.1) can have the same inertial rotary as the blade housing connector (108).

In one or more embodiments, the mechanical connection components keep the blade housing (e.g., 200, FIG. 2.1) connected to blade housing connector (108). The mechanical connection components also provide structural support to the blade housing (e.g., 200, FIG. 2.1) while, for example, cutting the PT tendon tail (110). The mechanical connection components may be, for example (but not limited to): mechanical hard-stop components, sealing components, etc. The aforementioned examples are not intended to limit the scope of the invention.

In one or more embodiments, “connected” may refer to “directly connected”, in which there is a seal in between, for example, the connection interface of the blade housing connector (108) and a connection interface of the blade housing (e.g., 200, FIG. 2.1) (discussed below).

Alternatively, “connected” may refer to “connected via one or more physical components in between”. For example, the connection interface of the blade housing connector (108) is connected to the connection interface of the blade housing (e.g., 200, FIG. 2.1), in which at least one physical component is mechanically touching the connection interfaces.

In one or more embodiments, an area (e.g., height x width) enclosed by the connection interface of the blade housing connector (108) may be equal to an area enclosed by the connection interface of the blade housing (e.g., 200, FIG. 2.1). In this manner, a secure pairing between the blade housing connector (108) and the blade housing (e.g., 200, FIG. 2.1) may be installed for compatible mechanical connections.

In one or more embodiments, while affixing (e.g., attaching), the blade housing (e.g., 200, FIG. 2.1) may be releasably secured to the blade housing connector (108), for example, by its screw threads. However, it should be appreciated that the blade housing (e.g., 200, FIG. 2.1) may be releasably connected to the blade housing connector (108) through any other suitable means in order to impart rotational force on the blade housing (e.g., 200, FIG. 2.1). For this reason, other mechanical or non-mechanical mechanisms for releasably connecting the blade housing (e.g., 200, FIG. 2.1) to the blade housing connector (108) may be used without departing from the scope of the invention.

In one or more embodiments, the blade housing connector (108) may have openings to allow a tail (e.g., the PT tendon tail (110)) to extend through and out of the PT tendon tail cutting tool (100) while being cut. In one or more embodiments, the blade housing connector (108) may be made of, for example (but not limited to): galvanized steel, stainless steel, aluminum, glass-fiber reinforced plastic, etc. The aforementioned example is not intended to limit the scope of the invention.

In one or more embodiments, the blade housing connector (108) may include a safety feature, in which the blade housing connector (108) may prevent the blade housing (e.g., 200, FIG. 2.1) from rotating (e.g., spinning) while, for example, a customer is affixing the blade housing (e.g., 200, FIG. 2.1) to the blade housing connector (108). In this manner, the customer may be protected from any damages (e.g., injuries) originated from a rotary blade (e.g., 208, FIG. 2.1).

Those skilled in the art will appreciate that while the blade housing connector (108) is shown as having a particular size, shape, and placement, the blade housing connector (108) may have any size, shape, and placement (while still providing the same functionalities) without departing from the scope of the invention.

In one or more embodiments, the small (e.g., handheld), lightweight, and portable form factor of the PT tendon tail cutting tool (100) described above makes the PT tendon tail cutting tool (100) usable in, for example, space-limited stressing pockets. Further, providing and fitting multiple functionalities into the small, lightweight, and portable form factor make transportation, usability, and operation of the PT tendon tail cutting tool (100) practical and easier for a customer. Specifically, these functionalities allow cutting a tail (e.g., the PT tendon tail (110)) in one step rather than in multiple steps. These functionalities may include, for example (but not limited to): a pre-integrated and ready-to-use blade housing, an ability to allow a tendon tail to extend through and out of the PT tendon tail cutting tool (100) while being cut, flexibility to support third-party components, a customer-specific component design, etc.

Turning now to FIG. 2.1, FIG. 2.1 shows an isometric view of the blade housing (200) in accordance with one or more embodiments of the invention. In an embodiment of the invention shown in FIG. 2.1, the embodiment includes a bottom housing component (202), a top housing component (204), and a rotary blade (208). As shown in FIG. 2.1, the blade housing (200) may be a mechanical structure that houses (e.g., hosts) the rotary blade (208), in which the rotary blade (208) is releasably secured between the bottom housing component (202) and the top housing component (204) such that the rotary blade (208) may be removed. In this manner, the rotary blade (208) may be replaced when the rotary blade (208) reaches to the end of its cutting life or the rotary blade (208) is worn out. Additional details of the bottom housing component, the top housing component, and the rotary blade are described below in reference to FIGS. 2.2 and 2.3.

In one or more embodiments, the blade housing (200) may be implemented as other types of structures adapted to host, position, orient, and/or otherwise physically, mechanically, and/or thermally manage the rotary blade (208). In this manner, the rotary blade (208) may be densely packed within the blade housing (200) without negatively impacting the operation of the rotary blade (208).

In one or more embodiments, the rotary blade (208) may be secured to both housing components (202, 204) via the standard mechanical mechanisms. For example, the blade housing (200) may hold the rotary blade (208) between the bottom housing component (202) and the top housing component (204) through a threaded connection. Other mechanical or non-mechanical mechanisms for securing the rotary blade (208) to (or between) both housing components (202, 204) may be used without departing from the scope of the invention. The aforementioned example is not intended to limit the scope of the invention.

In one or more embodiments, the blade housing (200) is sized and shaped to not only be able to rotate the rotary blade (208), but also to allow the rotary blade (208) to be inserted into a stressing pocket to cut a PT tendon tail (e.g., 206), in which the PT tendon tail (206) may be the same as the PT tendon tail (110) as discussed above in reference to FIG. 1. To do so, the blade housing (200) allows the rotary blade (208) to be inserted into the stressing pocket at a depth allowing for a sufficient concrete cover between an edge of a concrete slab and the cut end of the PT tendon tail being trimmed. Details of the concrete cover, the concrete slab, the stressing pocket, and the PT tendon tail are described above in reference to FIG. 1.

As discussed above in reference to FIG. 1, the blade housing (200) may be disposed within or may be affixed to the blade housing connector (108). Similar to the blade housing connector (e.g., 108, FIG. 1), the blade housing (200) may include a connection interface, in which the connection interface of the blade housing (200) refers to a portion of the blade housing (200) that can be connected to another component (e.g., the blade housing connector (e.g., 108, FIG. 1)). In one or more embodiments, the connection interface of the blade housing (200) includes mechanical connection components such that, when secured, (i) the blade housing (200) can rotate at the same speed as the blade housing connector (e.g., 108, FIG. 1) and (ii) the blade housing (200) can have the same inertial rotary as the blade housing connector (e.g., 108, FIG. 1). Details of the mechanical connection components are described above in reference to FIG. 1.

In one or more embodiments, the blade housing (200) may be snugly disposed within or may be snugly affixed to the blade housing connector (e.g., 108, FIG. 1) to enable the rotary blade (208) reaching high speed and high inertial rotary. In this manner, for example, (i) cutting off the PT tendon tail (206) may be facilitated, (ii) the rotary blade (208) may rotate at the same speed as the electric motor, (iii) the rotary blade (208) may have the same inertial rotary as the electric motor, and (iv) heat dissipation of the rotary blade (208) may be facilitated. The aforementioned examples are not intended to limit the scope of the invention.

Turning now to FIG. 2.2, FIG. 2.2 shows a side view of the blade housing (e.g., 200, FIG. 2.1) in accordance with one or more embodiments of the invention. As shown in FIG. 2.2, the blade housing (e.g., 200, FIG. 2.1) is manufactured as a non-monolithic system. Said another way, the bottom housing component (202), the top housing component (204), and the rotary blade (208) are manufactured separately (as standalone components), and then combined (e.g., attached, secured, etc.) together to form the blade housing (e.g., 200, FIG. 2). While forming the blade housing (200), for example, the rotary blade (208) may be affixed to the bottom housing component (202), then the top housing component (204) may be affixed to the bottom housing component (202), in which the rotary blade (208) stays in between the bottom and top housing components (202, 204).

Further, double-headed arrows show modularity of the components, in which (i) the rotary blade (208) may be attached to, or detached from the bottom housing component (202) along the same direction, (ii) the rotary blade (208) may be attached to, or detached from the top housing component (204) along the same direction, and (iii) the top housing component (204) may be attached to, or detached from the bottom housing component (202) along the same direction.

In one or more embodiments, the bottom housing component (202) includes a top opening, a bottom side, and a curved side (e.g., a side wall). The bottom side of the bottom housing component (202) includes an opening (216), in which the opening (216), the top opening, and a center opening of the rotary blade (208) (see FIG. 2.4) allow the PT tendon tail (e.g., 206, FIG. 2.1) to extend through and out of the blade housing (200) while being cut. In one or more embodiments, while being cut, the PT tendon tail (e.g., 206, FIG. 2.1) may be handled and removed from an interior of the bottom housing component (202), once cut.

In one or more embodiments, the blade housing (e.g., 200, FIG. 2.1) may be releasably affixed to the blade housing connector (e.g., 108, FIG. 1) through, for example, screw threads (not shown) of the bottom housing component (202), in which the bottom side of the bottom housing component (202) includes the screw threads. Other mechanical or non-mechanical mechanisms for releasably affixing the blade housing (e.g., 200, FIG. 2.1) to the blade housing connector (e.g., 108, FIG. 1) may be used without departing from the scope of the invention.

In one or more embodiments, a length of the bottom housing component (202) may vary to allow the PT tendon tail (e.g., 206, FIG. 2.1) to fit into the bottom housing component (202). In most cases, a PT tendon tail may be at least twelve inches long (protruding from an edge of a concrete slab) in order for it to be stressed, in which the stressing of the PT tendon tail (e.g., 206, FIG. 2.1) elongates the PT tendon tail (e.g., 206, FIG. 2.1) according to the tendon length inside the concrete slab.

In one or more embodiments, the edge of the top opening includes one or more slots (e.g., 214A-214C, FIG. 2.3), in which one or more protrusions of the rotary blade (208) are affixed to (e.g., placed into) these slots (e.g., slits, grooves, etc.). As shown in FIG. 2.4, the protrusions are located at an outer edge (212) of the rotary blade (208), in which the protrusions acts as mechanical connection components.

Those skilled in the art will appreciate that while protrusions are used in conjunction with the slots (e.g., 214A-214C, FIG. 2.3) to secure the rotary blade (208) to the bottom housing component (202), any other mechanical or non-mechanical components may be used to secure the rotary blade (208) to bottom housing component without departing from the scope of the invention.

In one or more embodiments, as being mechanical hard-stop components, both the slots (e.g., 214A-214C, FIG. 2.3) and the protrusions keep the rotary blade (208) connected to the bottom housing component (202). The slots (e.g., 214A-214C, FIG. 2.3) and the protrusions also provide structural support to the rotary blade (208) while, for example, cutting the PT tendon tail (e.g., 206, FIG. 2.2). Additional details of the slots and the rotary blade are described below in reference to FIGS. 2.3 and 2.4, respectively. The aforementioned example is not intended to limit the scope of the invention.

In one or more embodiments, the curved side of the bottom housing component (202) may include one or more openings (e.g., holes). The openings may have a functionality to provide cooling air into the blade housing (e.g., 200, FIG. 2.1). In this manner, the rotary blade (208) may receive adequate cooling and may be protected from overheating, for example, while a cutting edge (210) of the rotary blade (208) cutting a PT tendon tail. Further, the openings may also have a functionality to act as getaway points. In this manner, for example, if the bottom housing component (202) becomes stuck inside the blade housing component (e.g., 108, FIG. 1), a customer may stick a component (e.g., a screw driver) through one of the openings and may loosen the bottom housing component (202). The aforementioned examples are not intended to limit the scope of the invention.

In one or more embodiments, the openings may have any size and shape, and may be placed at any location on the curved side of the bottom housing component (202) without departing from the scope of the invention.

In one or more embodiments, the bottom housing component (202) may be made of, for example (but not limited to): galvanized steel, stainless steel, aluminum, glass-fiber reinforced plastic, etc. The aforementioned example is not intended to limit the scope of the invention.

Those skilled in the art will appreciate that while the bottom housing component (202) is shown as having a particular size and shape, the bottom housing component (202) may have any size and shape (while still providing the same functionalities) without departing from the scope of the invention.

In one or more embodiments, the top housing component (204) includes a top opening (e.g., 230, FIG. 2.5), a bottom opening, and a curved side. Both openings of the top housing component (204) allow the PT tendon tail (e.g., 206, FIG. 2.1) to extend through and out of the blade housing (200) while being cut. In one or more embodiments, while being cut, the PT tendon tail (e.g., 206, FIG. 2.1) may be handled and removed from an interior of the top housing component (204), once cut.

In one or more embodiments, similar to the bottom housing component (202), a length of the top housing component (204) may vary to allow the PT tendon tail (e.g., 206, FIG. 2.1) to fit into the top housing component (204). In one or more embodiments, the top housing component (204) may act as a mechanical hard-stop component. In this manner, for example, (i) the top housing component (204) makes sure that the rotary blade (208)-affixed bottom housing component (202) is ready-to-use when a PT tendon tail needs to be cut and (ii) the top housing component (204) provides structural support to keep the rotary blade (208) connected to the bottom housing component (202) while cutting the PT tendon tail (e.g., 206, FIG. 2.2). The aforementioned example is not intended to limit the scope of the invention.

Further, the top opening (e.g., 230, FIG. 2.5) of the top housing component (204) may have a functionality to provide cooling air to the rotary blade (208). In this manner, the rotary blade (208) may receive adequate cooling and may be protected from overheating, for example, while the cutting edge (210) of the rotary blade (208) cutting a PT tendon tail. The top housing component (204) may also have a functionality to provide a shock isolation to the rotary blade (208) such that the rotary blade (208) may be protected from any vibrational damage.

In one or more embodiments, to further improve the cooling of the rotary blade (208), the curved side of the top housing component (204) may include one or more openings, in which the openings may have a functionality to provide cooling air to the rotary blade (208).

In one or more embodiments, the openings may have any size and shape, and may be placed at any location on the curved side of the top housing component (204) without departing from the scope of the invention.

In one or more embodiments, the top housing component (204) may be made of, for example (but not limited to): galvanized steel, stainless steel, aluminum, glass-fiber reinforced plastic, etc. The aforementioned example is not intended to limit the scope of the invention.

Those skilled in the art will appreciate that while the top housing component (204) is shown as having a particular size and shape, the top housing component (204) may have any size and shape (while still providing the same functionalities) without departing from the scope of the invention.

Turning now to FIG. 2.3, FIG. 2.3 shows a top view of the bottom housing component (202) in accordance with one or more embodiments of the invention. As shown in FIG. 2.3, the bottom side of the bottom housing component (202) includes the opening (216) and the edge of the top opening includes the slots (214A-214C). The bottom housing component (202) may include additional, fewer, and/or different components without departing from the scope of the invention. For example, the bottom side of the bottom housing component (202) may include screw threads in order to releasably affix the blade housing (e.g., 200, FIG. 2.1) to the blade housing connector (e.g., 108, FIG. 1).

In one or more embodiments, the opening (216) may have a functionality to provide cooling air into the blade housing (e.g., 200, FIG. 2.1). In this manner, the rotary blade (e.g., 208, FIG. 2.2) may receive adequate cooling and may be protected from overheating.

Those skilled in the art will appreciate that while the opening (216) is shown as having a particular size, shape, and placement, the opening (216) may have any size, shape, and placement (while still providing the same functionalities) without departing from the scope of the invention. For example, based on a width of a PT tendon tail (that needs to be cut), the diameter of the opening (216) may be increased or decreased. As yet another example, in order to improve cooling of the rotary blade (e.g., 208, FIG. 2.2), the diameter of the opening (216) may be increased and/or the shape of the opening (216) may be altered. The aforementioned examples are not intended to limit the scope of the invention.

Further, the slots (214A-214C) may have a functionality to act as heat exchangers, in which the slots (214A-214C) may remove a heat generated by the rotary blade (e.g., 208, FIG. 2.2) away from the rotary blade (e.g., to the bottom housing component (202)). In this manner, the rotary blade (e.g., 208, FIG. 2.2) may be protected from overheating.

Those skilled in the art will appreciate that while the slots (214A-214C) are shown as having a particular size, shape, and placement, the slots (214A-214C) may have any size, shape, and placement (while still providing the same functionalities) without departing from the scope of the invention.

Turning now to FIG. 2.4, FIG. 2.4 shows a top view of a circular, rotary blade (208) in accordance with one or more embodiments of the invention. As shown in FIG. 2.4, the rotary blade (208) includes a body (220) with a center opening (222), the cutting edge (e.g., a cutting area) (210), and the outer edge (212). As discussed above in reference to FIG. 2.2, the body (220) may include one or more protrusions in order to affix the rotary blade (208) to the slots (e.g., 214A-214C, FIG. 2.3). Details of the protrusions are described above in reference to FIG. 2.3.

In one or more embodiments, the protrusions may have any size and shape, and the protrusions may be placed at any location on the outer edge (212) without departing from the scope of the invention.

Those skilled in the art will appreciate that while the body (220) is shown as including one or more protrusions at the outer edge (212) (in order to keep the rotary blade (208) connected to the bottom housing component (e.g., 202, FIG. 2.2)), the body (220) may include no protrusions at the outer edge (212) (while still providing the same functionalities) without departing from the scope of the invention.

In one or more embodiments, the rotary blade (208) is a flat, planar blade that may be made of, for example (but not limited to): alumina ceramic, silicon carbide, diamond, stainless steel, cast iron, etc. The shape, form, and/or composition of the rotary blade (208) may be similar to, or like that of a conventional rotary saw blade used to cut metals or other substances. However, unlike conventional rotary blades, the rotary blade (208) includes the cutting edge (210) on an inner edge of the rotary blade (208) rather than the outer edge (212) of the rotary blade (208). Further, unlike conventional rotary blades that attach to a tool (e.g., an angle grinder, a chop saw, etc.) using an inner opening, the rotary blade (208) is connected to the PT tendon tail cutting tool (e.g., 100, FIG. 1) via the outer edge (212) of the rotary blade (208). Thus, with the rotary blade (208), the locations of the cutting edge (210) and an area where the rotary blade (208) is attached to the PT tendon tail cutting tool (e.g., 100, FIG. 1) are opposite to that of conventional rotary blades.

In one or more embodiments, even though the body (220) is made of, for example, stainless steel (in order to have a saw blade functionality), the cutting edge (210) may be coated with a material composition that cuts through a PT tendon tail, in which the cutting edge (210) may be coated with any material composition that may enhance a PT tendon tail cutting process (e.g., a PT tendon tail grinding process). For example, the cutting edge (210) may not need to be continuous around its entire circumference but may include diamond (e.g., manufactured, synthetic diamond) segments because of its durability (or resistance). In this manner, (i) life expectancy of the cutting edge (210), (ii) durability of the cutting edge (210), and (iii) accuracy of the PT tendon tail cutting process may be increased. In one or more embodiments, the diamond segments may be attached to the cutting edge (210) using vacuum brazing, sintering, or laser welding. The aforementioned example is not intended to limit the scope of the invention.

In one or more embodiments, after the cutting edge (210) is coated, for example, the diamond segments may appear as a surface roughness (see FIG. 2.4), in which the coated cutting edge (210) may provide a rougher cut. In order to provide a smoother, finer cut, the cutting edge (210) may include one or more parts (e.g., cutting teeth) (not shown) made of, for example, diamond, in which the cutting teeth may be integrated or welded onto the cutting edge (210). In this manner, a PT tendon tail may be cut with less effort. In one or more embodiments, the parts may have any size and shape, and may be placed at any location on the cutting edge (210) without departing from the scope of the invention.

As discussed above in reference to FIG. 2.1, the rotary blade (208) is a removable component, which means that the rotary blade (208) is not welded to the bottom housing component (e.g., 202, FIG. 2.1). In this manner, for example, the rotary blade (208) may be replaced with another rotary blade (e.g., a new rotary blade) if a corrosion event has occurred on a surface of the rotary blade (208). As yet another example, if the diameter of the cutting edge (210) is smaller than a diameter of a PT tendon tail that needs to be cut, the rotary blade (208) may be replaced with a suitable rotary blade that has a larger diameter cutting edge.

In one or more embodiments, the body (220) of the rotary blade (208) includes a sufficient distance between the innermost circumferential part of the cutting edge (210) and the outermost circumferential part of the outer edge (212) to provide structural rigidity needed for cutting a PT tendon tail. For example, the distance between the innermost circumferential part of the cutting edge (210) and the outermost circumferential part of the outer edge (212) may be at least a half-width of a PT tendon tail that needs to be cut. As yet another example, the diameter of the center opening (222) may be at least a half-inch wide for a PT tendon tail to extend through (e.g., pass thru) the rotary blade (208). The aforementioned examples are not intended to limit the scope of the invention.

In one or more embodiments, the center opening (222) may be sized and shaped to fit around a PT tendon tail that is being cut. In this manner, the rotary blade (208) may be rotated at sufficient speed to cut the PT tendon tail inside a stressing pocket.

In one or more embodiments, the rotary blade (208) may have a diameter that allows the rotary blade (208) to be inserted into a stressing pocket and to complete the cutting process of a PT tendon tail. As discussed above in reference to FIG. 1, for example, the width of the pocket may be 3 inches (7.6 centimeters) at the edge of the concrete slab, and because of its frusto-conical shape, the width of the pocket may be 2.5 inches (6.35 centimeters) where a tails needs to be cut. For this reason, the diameter of the outer edge (212) is small enough to fit within the stressing pocket, while the diameter of the cutting edge (210) is large enough to fit around a PT tendon tail that is being cut.

In one or more embodiments, the cutting process may be accomplished by multi-directional movements in lateral directions as needed to cut (abrasively) the PT tendon tail inside the pocket. While example dimensions are given above, it should be appreciated that dimensions of the stressing pocket (and the PT tendon tail) may vary and, thus, the PT tendon tail cutting tool (e.g., 100, FIG. 1) may be designed to accommodate rotary blades of different sizes.

Further, in operation, after the blade housing (e.g., 200, FIG. 2.1) is releasably attached to the blade housing connector (e.g., 108, FIG. 1) with the rotary blade (208), the blade housing (e.g., 200, FIG. 2.1) is placed over the PT tendon tail (e.g., 110, FIG. 1) such that the PT tendon tail (e.g., 110, FIG. 1) extends through the center opening (222). The engagement of the initiation mechanism (e.g., 106, FIG. 1) provides power to the electric motor to rotate the blade housing connector (e.g., 108, FIG. 1), and, thus, also the blade housing (e.g., 200, FIG. 2.1) and the rotary blade (208). The PT tendon tail cutting tool (e.g., 100, FIG. 1) is then moved to engage the cutting edge (210) of the rotary blade (208) with the PT tendon tail (e.g., 110, FIG. 1) enough so that the rotary blade (208) cuts through the entire tail at the appropriate location. The cut portion of the PT tendon tail (e.g., 110, FIG. 1) may then be removed.

Turning now to FIG. 2.5, FIG. 2.5 shows a top view of the top housing component (204) in accordance with one or more embodiments of the invention. As shown in FIG. 2.5, the top housing component (204) includes the top opening (230). Referring to FIG. 2.1, the top housing component (204) may include additional, fewer, and/or different components without departing from the scope of the invention.

In one or more embodiments, the top opening (230) may allow the PT tendon tail (e.g., 206, FIG. 2.1) to extend through and out of the top housing component (204) while being cut. Details of the top housing component (204) are described above in reference to FIG. 2.2.

In one or more embodiments, the top housing component (204) may be secured to the bottom housing component (e.g., 202, FIG. 2.2) via the standard mechanical mechanisms. For example, the top housing component (204) may be secured to the bottom housing component (e.g., 202, FIG. 2.2) through a threaded connection. Other mechanical or non-mechanical mechanisms for securing the top housing component (204) to the bottom housing component (e.g., 202, FIG. 2.2) may be used without departing from the scope of the invention.

Those skilled in the art will appreciate that while the top opening (230) is shown as having a particular size, shape, and placement, the top opening (230) may have any size, shape, and placement (while still providing the same functionalities) without departing from the scope of the invention. For example, based on a width of a PT tendon tail (that needs to be cut), the diameter of the top opening (230) may be increased or decreased. As yet another example, in order to improve cooling of the rotary blade (e.g., 208, FIG. 2.4), the diameter of the top opening (230) may be increased and/or the shape of the top opening (230) may be altered. The aforementioned examples are not intended to limit the scope of the invention.

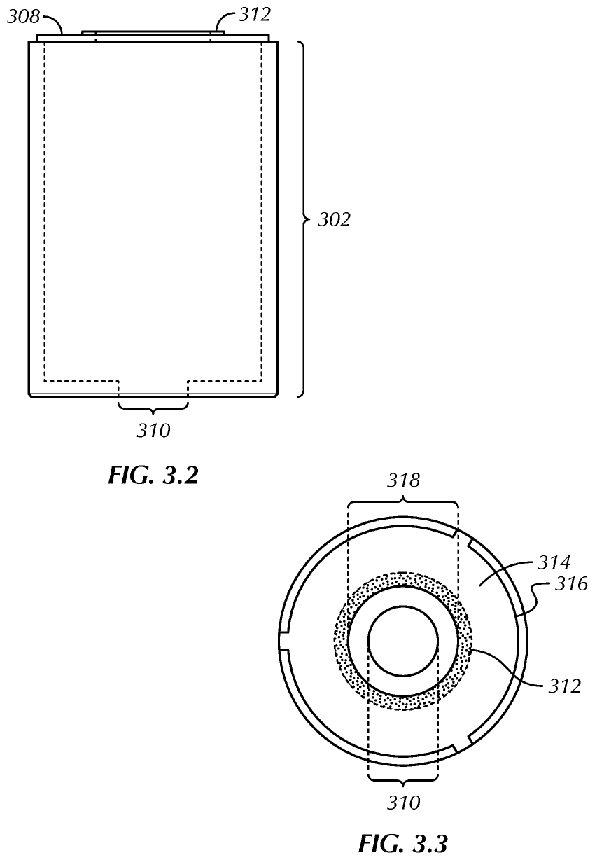

Turning now to FIG. 3.1, FIG. 3.1 shows an isometric view of a blade housing (300) in accordance with one or more embodiments of the invention. In an embodiment of the invention shown in FIG. 3.1, the embodiment includes a bottom housing component (302) and a rotary blade (308). The bottom housing component (302) may be the same as the bottom housing component (202) as discussed above in reference to FIG. 2.2. Similarly, the rotary blade (308) may be the same as the rotary blade (208) as discussed above in reference to FIG. 2.4.

In comparison to the embodiment shown in FIG. 2.1 and as an alternative embodiment, the rotary blade (308) is permanently affixed (e.g., welded, integrated, etc.) to the bottom housing component (302), in which the rotary blade (308) is a part of the bottom housing component (302) that has a hollow body. For example, the rotary blade (308) may be attached as a “cap” on one end of the bottom housing component (302), while the opposite end of the bottom housing component (302) may be attached to the blade housing connector (e.g., 108, FIG. 1). In this configuration, a top housing component (e.g., 204, FIG. 2.2) would not be needed and, as such, is not included in this embodiment.

As shown in FIG. 3.1, the rotary blade-integrated bottom housing component is a monolithically manufactured system, in which the rotary blade (308) is not releasably secured to the bottom housing component (302). Said another way, the rotary blade (308) is not a separate, standalone component. For this reason, the rotary blade (308) may not be replaced when the rotary blade (308) reached to the end of its cutting life or the rotary blade (308) is worn out. However, as being a disposable component, when the rotary blade (308) is worn out, the blade housing (300) may be replaced with another blade housing.

In one or more embodiments, the blade housing (300) may be a mechanical structure (or any other type of structure) adapted to host, position, orient, and/or otherwise physically, mechanically, and/or thermally manage the rotary blade (308). In this manner, the rotary blade (308) may be mounted on one side of the blade housing (300) without negatively impacting the operation of the rotary blade (308).

As used herein, “mounting” a particular component on another component refers to positioning the particular component to be in physical contact with the other component, such that the other component provides structural support, positioning, structural load transfer, stabilization, shock absorption, some combination thereof, or the like with regard to that particular component.

In one or more embodiments, the rotary blade (308) may be permanently affixed to the bottom housing component (302) via standard mechanical mechanisms (e.g., via welding). Other mechanical or non-mechanical mechanisms for permanently affixing the rotary blade (308) to the bottom housing component (302) may be used without departing from the scope of the invention.

In one or more embodiments, the blade housing (300) is sized and shaped to not only be able to rotate the rotary blade (308), but also to allow the rotary blade (308) to be inserted into a stressing pocket to cut a PT tendon tail (e.g., 306), in which the PT tendon tail (306) may be the same as the PT tendon tail (110) as discussed above in reference to FIG. 1. To do so, the blade housing (300) allows the rotary blade (308) to be inserted into the stressing pocket at a depth allowing for a sufficient concrete cover between an edge of a concrete slab and the cut end of the PT tendon tail being trimmed.

As discussed above in reference to FIG. 1, the blade housing (300) may be disposed within or may be affixed to the blade housing connector (108). Similar to the blade housing connector (e.g., 108, FIG. 1), the blade housing (300) may include a connection interface, in which the connection interface of the blade housing (300) refers to a portion of the blade housing (300) that can be connected to another component (e.g., the blade housing connector (e.g., 108, FIG. 1)). In one or more embodiments, the connection interface of the blade housing (300) includes mechanical connection components such that, when secured, (i) the blade housing (300) can rotate at the same speed as the blade housing connector (e.g., 108, FIG. 1) and (ii) the blade housing (300) can have the same inertial rotary as the blade housing connector (e.g., 108, FIG. 1).

In one or more embodiments, the blade housing (300) may be snugly disposed within or may be snugly affixed to the blade housing connector (e.g., 108, FIG. 1) to enable the rotary blade (308) to reach high speed and high inertial rotary. In this manner, for example, (i) cutting-off the PT tendon tail (306) may be facilitated, (ii) the rotary blade (308) may rotate at the same speed as the electric motor, (iii) the rotary blade (308) may have the same inertial rotary as the electric motor, and (iv) heat dissipation of the rotary blade (308) may be facilitated.

Turning now to FIG. 3.2, FIG. 3.2 shows a side view of the blade housing (e.g., 300, FIG. 3.1) in accordance with one or more embodiments of the invention. As shown in FIG. 3.2, the blade housing (e.g., 300, FIG. 3.1) is manufactured as a monolithic system.

In one or more embodiments, the bottom housing component (302) includes a top opening, a bottom side, and a curved side, in which the rotary blade (308) is attached to top opening as a cap. The bottom side of the bottom housing component (302) includes an opening (310), in which the opening (310) and a center opening of the rotary blade (308) (see FIG. 3.3) allow the PT tendon tail (e.g., 306, FIG. 3.1) to extend through and out of the blade housing (300) while being cut. In one or more embodiments, while being cut, the PT tendon tail (e.g., 306, FIG. 3.1) may be handled and removed from an interior of the bottom housing component (302), once cut.

In one or more embodiments, the blade housing (e.g., 300, FIG. 3.1) may be releasably affixed to the blade housing connector (e.g., 108, FIG. 1) through, for example, screw threads (not shown) of the bottom housing component (302), in which the bottom side of the bottom housing component (302) includes the screw threads. Other mechanical or non-mechanical mechanisms for releasably affixing the bottom housing component (302) to the blade housing connector (e.g., 108, FIG. 1) may be used without departing from the scope of the invention.

In one or more embodiments, a length of the bottom housing component (302) may vary to allow the PT tendon tail (e.g., 306, FIG. 3.1) to fit into the bottom housing component (302). Further, the edge of the top opening may include one or more slots, in which one or more protrusions of the rotary blade (308) are integrated into these slots. Details of the slots and the rotary blade are described above in reference to FIGS. 2.2 and 2.4, respectively.

Those skilled in the art will appreciate that while protrusions are used to integrate the rotary blade (308) to the slots, any other mechanical or non-mechanical components may be used to integrate the rotary blade (308) to the slots without departing from the scope of the invention.

In one or more embodiments, the curved side of the bottom housing component (302) may include one or more openings (not shown). The openings may have a functionality to provide cooling air into the blade housing (e.g., 300, FIG. 3.1). In this manner, the rotary blade (308) may receive adequate cooling and may be protected from overheating, for example, while a cutting edge (312) of the rotary blade (308) cutting a PT tendon tail. Further, the openings may also have a functionality to act as getaway points. In this manner, for example, if the bottom housing component (302) becomes stuck inside the blade housing component (e.g., 108, FIG. 1), a customer may stick a component through one of the openings and may loosen the bottom housing component. The aforementioned examples are not intended to limit the scope of the invention.

In one or more embodiments, the openings may have any size and shape, and may be placed at any location on the curved side of the bottom housing component (302) without departing from the scope of the invention.

Those skilled in the art will appreciate that while the bottom housing component (302) is shown as having a particular size and shape, the bottom housing component (302) may have any size and shape (while still providing the same functionalities) without departing from the scope of the invention.

Turning now to FIG. 3.3, FIG. 3.3 shows a top view of the blade housing (e.g., 300, FIG. 3.1) in accordance with one or more embodiments of the invention. As shown in FIG. 3.3, the bottom side of the bottom housing component (e.g., 302, FIG. 3.2) includes the opening (310) and the rotary blade (e.g., 308, FIG. 3.2) is attached to the top opening of the bottom housing component (e.g., 302, FIG. 3.2). The bottom housing component (e.g., 302, FIG. 3.2) may include additional, fewer, and/or different components without departing from the scope of the invention. For example, the bottom side of the bottom housing component (e.g., 302, FIG. 3.2) may include screw threads in order to releasably affix the blade housing (e.g., 300, FIG. 3.1) to the blade housing connector (e.g., 108, FIG. 1).

In one or more embodiments, the opening (310) may have a functionality to provide cooling air into the blade housing (e.g., 300, FIG. 3.1). In this manner, the rotary blade (e.g., 308, FIG. 3.2) may receive adequate cooling and may be protected from overheating.

Those skilled in the art will appreciate that while the opening (310) is shown as having a particular size, shape, and placement, the opening (310) may have any size, shape, and placement (while still providing the same functionalities) without departing from the scope of the invention. For example, based on a width of a PT tendon tail (that needs to be cut), the diameter of the opening (310) may be increased or decreased. As yet another example, in order to improve cooling of the rotary blade (e.g., 308, FIG. 3.2), the diameter of the opening (310) may be increased and/or the shape of the opening (310) may be altered. The aforementioned examples are not intended to limit the scope of the invention.

As shown in FIG. 3.3, the rotary blade (e.g., 308, FIG. 3.2) includes a body (314) with a center opening (318), the cutting edge (312), and an outer edge (316). In one or more embodiments, the body (314) may include one or more protrusions to permanently affix the rotary blade (e.g., 308, FIG. 3.2) to the slots.

In one or more embodiments, the protrusions may have any size and shape, and the protrusions may be placed at any location on the outer edge (316) without departing from the scope of the invention.

Those skilled in the art will appreciate that while the body (314) is shown as including one or more protrusions at the outer edge (316) (to permanently affix the rotary blade (e.g., 308, FIG. 3.2) to the bottom housing component (e.g., 302, FIG. 3.2)), the body (314) may include no protrusions at the outer edge (316) (while still providing the same functionalities) without departing from the scope of the invention.

In one or more embodiments, because the rotary blade (e.g., 308, FIG. 3.2) is not a removable component, for example, when a corrosion event has occurred on a surface of the rotary blade (e.g., 308, FIG. 3.2), the entire blade housing (e.g., 300, FIG. 3.1) may need to be replaced. As yet another example, if the diameter of the cutting edge (312) is smaller than a diameter of a PT tendon tail needs to be cut, the entire blade housing (e.g., 300, FIG. 3.1) may need to be replaced in order to have a suitable rotary blade that has a larger diameter cutting edge. The aforementioned examples are not intended to limit the scope of the invention.

In one or more embodiments, the center opening (318) may be sized and shaped to fit around a PT tendon tail that is being cut. In this manner, the rotary blade (e.g., 308, FIG. 3.2) may be rotated at sufficient speed to cut the PT tendon tail inside a stressing pocket.

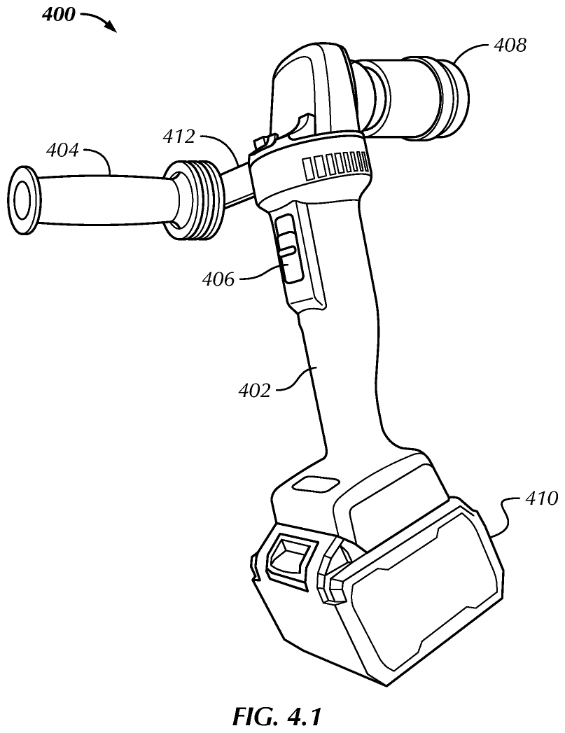

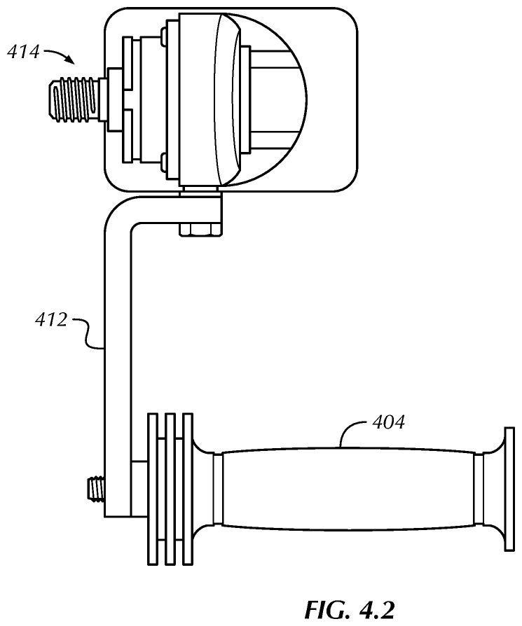

Turning now to FIG. 4.1, FIG. 4.1 shows a diagram of a PT tendon tail cutting tool (400) in accordance with one or more embodiments of the invention. The embodiment shown in FIG. 4.1 is an alternative embodiment to the PT tendon tail cutting tool (100) described above in reference in FIG. 1. The PT tendon tail cutting tool (400) includes a body (402), a handle (404), an initiation mechanism (406), a blade housing (408), a battery pack (410), a handle adapter (412), and an electric motor (not shown). The PT tendon tail cutting tool (400) may include additional, fewer, and/or different components without departing from the scope of the invention. The body (402) may be the same as the body (102) as discussed above in reference to FIG. 1, except the blade housing connector (108). Similarly, (i) the handle (404) may be the same as the handle (104) and (ii) the initiation mechanism (406) may be the same as the initiation mechanism (106) as discussed above in reference to FIG. 1.

In an embodiment of the invention shown in FIG. 4.1, the body (402) may be a mechanical structure that enables the handle (404), the initiation mechanism (406), the blade housing (408), the battery pack (410), the handle adapter (412), and the electric motor to be disposed within or to be affixed to the body (402).

In one or more embodiments, while disposing, the electric motor may be affixed within the body (402) via standard mechanical mechanisms. Other mechanical or non-mechanical mechanisms for affixing the electric motor within the body (402) may be used without departing from the scope of the invention. Details of the electric motor and the body are described above in reference to FIG. 1.

In an embodiment of the invention shown in FIG. 4.1, the blade housing (408) houses the rotary blade (e.g., 208, FIG. 2.4); however, the blade housing (408) does not releasably connect to the PT tendon tail cutting tool (400) via a specifically designed blade housing connector (e.g., 108, FIG. 1). Instead, the blade housing (408) may include a connection component (not shown) that is suitable to releasably connect to a spindle (e.g., 414, FIG. 4.2) of the PT tendon tail cutting tool (400) (and of other conventional rotary devices (e.g., angle grinders, polishers, drills, etc.) that are powered by any suitable means (e.g., via a battery pack, via a cord, etc.)). For example, the connection component may be located at a bottom side of the blade housing (408) and may include screw threads (in order to connect to the spindle (e.g., 414, FIG. 4.2)). With this functionality, the blade housing (408) may be retrofit to any conventional rotary device. The aforementioned example is not intended to limit the scope of the invention.

In the above discussed configuration, the connection component (e.g., the connection area) of the blade housing (408) may be open to receive connection means of the PT tendon tail cutting tool (400); however, the connection component may not be open for a PT tendon tail (e.g., 110, FIG. 1) to extend through a bottom housing component of the blade housing (408). More specifically, the connection area may include an opening, but the opening may not be suitable (e.g., may not be big enough) for a PT tendon tail (e.g., 110, FIG. 1) to extend through (e.g., the depth of the PT tendon tail may stop at the end of the bottom housing component). For example, the diameter of the opening may be less than a half-inch, and thus a half-inch wide PT tendon tail may not extend through the opening. The aforementioned example is not intended to limit the scope of the invention.

In operation, a PT tendon tail may first be cut close to the outside of the stressing pocket using a conventional rotary device, in order to allow the length of the bottom housing component to be minimized. The remaining portion of the PT tendon tail that is still protruding from the stressing pocket may then be cut using the PT tendon tail cutting tool (400). In order to do that, after the blade housing (408) is releasably connected to the PT tendon tail cutting tool (400) via the connector component, the blade housing (408) is placed over the remaining portion of the PT tendon tail such that the PT tendon tail extends through the rotary blade (e.g., 208, FIG. 2.4) of the blade housing (408). The engagement of the initiation mechanism (406) provides power (from the battery pack (410)) to the electric motor to rotate the blade housing (408), and thus also the rotary blade. The PT tendon tail cutting tool (400) is then moved to engage the rotary blade with the remaining portion of the PT tendon tail enough so that the rotary blade cuts through the remaining portion at the appropriate location. The remaining portion may then be removed.

Further, because the blade housing (408) is a modular component, (i) a customer may connect the blade housing (408) to the PT tendon tail cutting tool (400) at the customer site, or (ii) the customer may remove the pre-connected blade housing (408) from the PT tendon tail cutting tool (400) and connect a different type of blade housing without worrying about resource intensive efforts.

As discussed above in reference to FIG. 1, the handle (404) may have a functionality to improve accuracy, usability, and maneuverability of the PT tendon tail cutting tool (400) for a customer. The handle (404) may also have a functionality to act as a mechanical hard-stop component. In this manner, the handle (404) may provide structural support to the body (402) while, for example, cutting a PT tendon tail.

In order to improve movement flexibility, operational safety, accuracy, and stabilization of the PT tendon tail cutting tool (400), the handle (404) may be attached to the handle adapter (412). The handle-attached handle adapter (e.g., the handle adapter (412)) may be affixed to any side of the body (402) using standard mechanical mechanisms. Other mechanical or non-mechanical mechanisms for affixing the handle-attached handle adapter to the body (402) may be used without departing from the scope of the invention. For example, the handle-attached handle adapter may be affixed to right side and/or left side of the body (402) such that the PT tendon tail cutting tool (400) may be used by right- and/or left-handed customers.

In one or more embodiments, the handle adapter (412) may be made of, for example (but not limited to): galvanized steel, stainless steel, aluminum, glass-fiber reinforced plastic, etc.

Those skilled in the art will appreciate that while the handle adapter (412) is shown as having a particular size, shape, and placement, the handle adapter (412) may have any size, shape, and placement (while still providing the same functionalities) without departing from the scope of the invention.

In one or more embodiments, the handheld, lightweight, and portable form factor of the PT tendon tail cutting tool (400) described above makes the PT tendon tail cutting tool (400) usable in, for example, space-limited stressing pockets. Further, providing and fitting multiple functionalities into the handheld, lightweight, and portable form factor make transportation, usability, and operation of the PT tendon tail cutting tool (400) practical and easier for a customer. Specifically, these functionalities allow cutting a tail (e.g., the PT tendon tail (110)) in multiple steps rather than in one step (as discussed above in reference to FIG. 1). These functionalities may include, for example (but not limited to): a pre-connected and ready-to-use blade housing, flexibility to support third-party components, a customer-specific component design, etc.

Turning now to FIG. 4.2, FIG. 4.2 shows a top view of the PT tendon tail cutting tool (400) in accordance with one or more embodiments of the invention. As shown in FIG. 4.2, the PT tendon tail cutting tool (400) also includes the spindle (414), in which the connection component is releasably connected to the spindle (414).

As used herein, a “spindle” is a circular protrusion located on a top portion (or any other portion) of the body (e.g., 402, FIG. 4.1), in which one end of the spindle (414) is connected to the blade housing (e.g., 408, FIG. 4.1). The opposite end of the spindle (414) may be directly connected to the electric motor via a belt (or via a set of bevel gears) in order to rotate the blade housing (e.g., 408, FIG. 4.1). The spindle (414) may include a “spindle lock mechanism” (as a safety feature) to prevent the spindle (414) rotating while, for example, connecting the blade housing (e.g., 408, FIG. 4.1) to the spindle (414). The aforementioned example is not intended to limit the scope of the invention.

In one or more embodiments, the spindle (414) may be made of, for example (but not limited to): galvanized steel, stainless steel, aluminum, glass-fiber reinforced plastic, etc.

As discussed above in reference to FIG. 4.1, to improve movement flexibility, operational safety, accuracy, and stabilization of the PT tendon tail cutting tool (400), the handle (404) may be attached to the handle adapter (412). As shown in FIG. 4.2, the handle-attached handle adapter is affixed to the left side of the body (e.g., 402, FIG. 4.1), for example, to improve movement flexibility of left-handed customers. The aforementioned example is not intended to limit the scope of the invention.

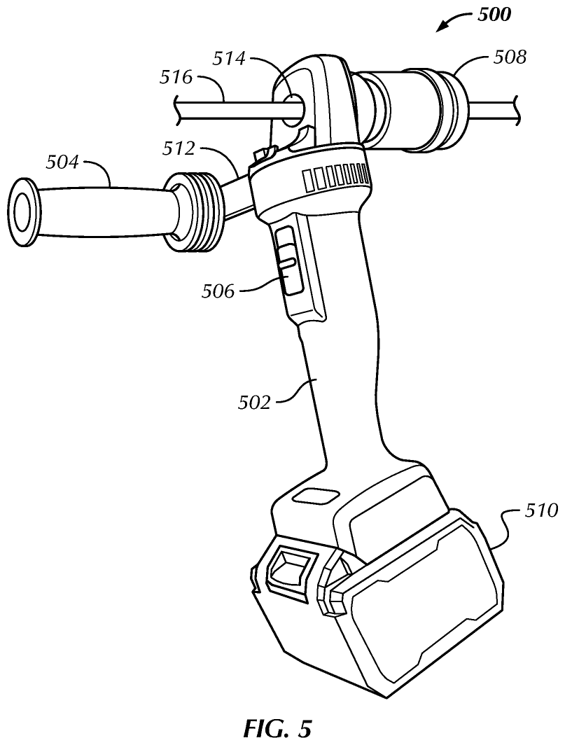

Turning now to FIG. 5, FIG. 5 shows a diagram of a PT tendon tail cutting tool (500) in accordance with one or more embodiments of the invention. The embodiment shown in FIG. 5 is an alternative embodiment to the PT tendon tail cutting tool (100) described above in reference in FIG. 1. The PT tendon tail cutting tool (500) includes a body (502), a handle (504), an initiation mechanism (506), a blade housing (508), a battery pack (510), a handle adapter (512), a top opening (514), and an electric motor (not shown). The PT tendon tail cutting tool (500) may include additional, fewer, and/or different components without departing from the scope of the invention. The body (502) may be the same as the body (102) as discussed above in reference to FIG. 1, except the blade housing connector (108). Similarly, (i) the handle (504) may be the same as the handle (104) and (ii) the initiation mechanism (506) may be the same as the initiation mechanism (106) as discussed above in reference to FIG. 1.

In an embodiment of the invention shown in FIG. 5, the body (502) may be a mechanical structure that enables the handle (504), the initiation mechanism (506), the blade housing (508), the battery pack (510), the handle adapter (512), the top opening (514), and the electric motor to be disposed within or to be affixed to the body (502).

In one or more embodiments, while disposing, the electric motor may be affixed within the body (502) via standard mechanical mechanisms. Other mechanical or non-mechanical mechanisms for affixing the electric motor within the body (502) may be used without departing from the scope of the invention. Details of the electric motor and the body are described above in reference to FIG. 1.

In an embodiment of the invention shown in FIG. 5, the blade housing (508) houses the rotary blade (e.g., 208, FIG. 2.4); however, the blade housing (508) does not releasably connect to the PT tendon tail cutting tool (500) via a specifically designed blade housing connector (e.g., 108, FIG. 1). Instead, the blade housing (508) may include a connection component (not shown) that is suitable to releasably connect to a spindle (not shown) of the PT tendon tail cutting tool (500). For example, the connection component may be located at a bottom side of the blade housing (508) and may include screw threads (in order to connect to the spindle). The aforementioned example is not intended to limit the scope of the invention.

In the above discussed configuration, the connection component of the blade housing (508) (i) may be open to receive connection means of the PT tendon tail cutting tool (500) and (ii) may be open for a PT tendon tail (516) to extend through the blade housing (508) (and through the top opening (514)). More specifically, the connection component may include an opening that is big enough for the PT tendon tail (516) to extend through the blade housing (508). Consequently, the opening of the connection component, the top opening (514), and an opening of the spindle allow the PT tendon tail (516) to extend through and out of the blade housing (508) and the body (502) while being cut. During the PT tendon tail cutting process, the PT tendon tail (516) may be handled and removed from an interior of the blade housing (508), once cut.

In operation, after the blade housing (508) is releasably connected to the spindle, the blade housing (508) is placed over the PT tendon tail (516) such that the PT tendon tail (516) extends through the blade housing (508) and the body (502). The engagement of the initiation mechanism (506) provides power to the electric motor to rotate the blade housing (508), and thus also the rotary blade (e.g., 208, FIG. 2.4) of the blade housing (508). The PT tendon tail cutting tool (500) is then moved to engage the rotary blade with the PT tendon tail (516) enough so that the rotary blade cuts through the entire tail at the appropriate location. The cut portion of the PT tendon tail (516) may then be removed. Details of the PT tendon tail are described above in reference to FIG. 1.

Further, because the blade housing (508) is a modular component, (i) a customer may connect the blade housing (508) to the PT tendon tail cutting tool (500) at the customer site, or (ii) the customer may remove the pre-connected blade housing (508) from the PT tendon tail cutting tool (500) and connect a different type of blade housing without worrying about resource intensive efforts.

As discussed above in reference to FIG. 1, the handle (504) may have a functionality to improve accuracy, usability, and maneuverability of the PT tendon tail cutting tool (500) for a customer. The handle (504) may also have a functionality to act as a mechanical hard-stop component. In this manner, the handle (504) may provide structural support to the body (502) while, for example, cutting the PT tendon tail (516).

In order to improve movement flexibility, operational safety, accuracy, and stabilization of the PT tendon tail cutting tool (500), the handle (504) may be attached to the handle adapter (512). The handle-attached handle adapter (e.g., the handle adapter (512)) may be affixed to any side of the body (502) using standard mechanical mechanisms. Other mechanical or non-mechanical mechanisms for affixing the handle-attached handle adapter to the body (502) may be used without departing from the scope of the invention. For example, the handle-attached handle adapter may be affixed to right side and/or left side of the body (502) such that the PT tendon tail cutting tool (500) may be used by right- and/or left-handed customers.

Those skilled in the art will appreciate that while the handle adapter (512) is shown as having a particular size, shape, and placement, the handle adapter (512) may have any size, shape, and placement (while still providing the same functionalities) without departing from the scope of the invention.

In one or more embodiments, the handheld, lightweight, and portable form factor of the PT tendon tail cutting tool (500) described above makes the PT tendon tail cutting tool (500) usable in, for example, space-limited stressing pockets. Further, providing and fitting multiple functionalities into the small, lightweight, and portable form factor make transportation, usability, and operation of the PT tendon tail cutting tool (500) practical and easier for a customer. Specifically, these functionalities allow cutting a tail (e.g., the PT tendon tail (516)) in one step rather than in multiple steps. These functionalities may include, for example (but not limited to): a pre-connected and ready-to-use blade housing, an ability to allow a tendon tail to extend through and out of the PT tendon tail cutting tool (500) while being cut, flexibility to support third-party components, a customer-specific component design, etc.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A blade housing, comprising:
a rotary blade and an opening,
wherein the blade housing is configured to be affixed to a blade housing connector, and
wherein when a motor rotates the blade housing connector, the rotary blade rotates to cut a post-tension (PT) tendon tail inside a stressing pocket, wherein the blade housing is sized to fit within the stressing pocket, wherein the opening of the blade housing is sized to allow the PT tendon tail to be extended through the blade housing.

2. The blade housing of claim 1, further comprising:
a bottom housing component and a top housing component,
wherein the bottom housing component comprises a first side and a second side, wherein the first side and the second side are parallel to each other, wherein the opening is located on the first side,
wherein the rotary blade is removably affixed to the second side, wherein the rotary blade is sized to allow the PT tendon tail to be extended through the bottom housing component, and
wherein the top housing component is affixed to the bottom housing component to keep the rotary blade affixed to the second side, wherein the top housing component is sized to allow the PT tendon tail to be extended through the top housing component.

3. The blade housing of claim 1, further comprising:
a slot,
wherein the rotary blade comprises a protrusion, and
wherein the rotary blade is removably affixed to the blade housing by affixing the protrusion to the slot.

4. The blade housing of claim 1, further comprising:
a bottom housing component,
wherein the bottom housing component comprises a first side and a second side, wherein the first side and the second side are parallel to each other, wherein the opening is located on the first side, and
wherein the rotary blade is non-removably affixed to the second side, wherein the rotary blade is sized to allow the PT tendon tail to be extended through the bottom housing component.

5. The blade housing of claim 1, wherein the rotary blade comprises a center opening, a cutting edge, and an outer edge,
wherein the center opening is sized to allow the PT tendon tail to be extended through the rotary blade,
wherein the center opening is surrounded by the cutting edge, wherein when the rotary blade rotates, the cutting edge cuts the PT tendon tail, and
wherein the outer edge is affixed to the blade housing.

6. The blade housing of claim 5, wherein the outer edge comprises a protrusion, wherein the outer edge is affixed to the blade housing using the protrusion.

7. The blade housing of claim 5, wherein the cutting edge comprises a cutting teeth to cut the PT tendon tail.

8. The blade housing of claim 1, wherein the rotary blade is sized to fit within the stressing pocket to allow the rotary blade to be moved in lateral directions to cut the PT tendon tail.

9. A post-tension (PT) tendon tail cutting tool, comprising:
a blade housing, wherein the blade housing comprises a rotary blade and an opening;
a blade housing connector, wherein the blade housing is affixed to the blade housing connector, wherein the blade housing is sized to fit within the stressing pocket, wherein the opening of the blade housing is sized to not allow a PT tendon tail to be extended through the blade housing; and
a motor, wherein when the motor rotates the blade housing connector, the rotary blade rotates to cut the PT tendon tail inside a stressing pocket.

10. The PT tendon tail cutting tool of claim 9, wherein the blade housing further comprises a bottom housing component and a top housing component,
wherein the bottom housing component comprises a first side and a second side, wherein the first side and the second side are parallel to each other, wherein the opening is located on the first side,
wherein the rotary blade is removably affixed to the second side, wherein the rotary blade is sized to fit the PT tendon tail inside the bottom housing component, and
wherein the top housing component is affixed to the bottom housing component to keep the rotary blade affixed to the second side, wherein the top housing component is sized to allow the PT tendon tail to be extended through the top housing component.

11. The PT tendon tail cutting tool of claim 9,
wherein the blade housing further comprises a slot,
wherein the rotary blade comprises a protrusion, and
wherein the rotary blade is removably affixed to the blade housing by affixing the protrusion to the slot.

12. The PT tendon tail cutting tool of claim 9, wherein the blade housing further comprises a bottom housing component,
wherein the bottom housing component comprises a first side and a second side, wherein the first side and the second side are parallel to each other, wherein the opening is located on the first side, and
wherein the rotary blade is non-removably affixed to the second side, wherein the rotary blade is sized to fit the PT tendon tail inside the bottom housing component.

13. The PT tendon tail cutting tool of claim 9, wherein the rotary blade comprises a center opening, a cutting edge, and an outer edge,
wherein the center opening is sized to allow the PT tendon tail to be extended through the rotary blade,
wherein the center opening is surrounded by the cutting edge, wherein when the rotary blade rotates, the cutting edge cuts the PT tendon tail, and
wherein the outer edge is affixed to the blade housing.

14. The PT tendon tail cutting tool of claim 13, wherein the outer edge comprises a protrusion, wherein the outer edge is affixed to the blade housing using the protrusion.

15. The PT tendon tail cutting tool of claim 13, wherein the cutting edge comprises a cutting teeth to cut the PT tendon tail.

16. The PT tendon tail cutting tool of claim 9, wherein the rotary blade is sized to fit within the stressing pocket to allow the rotary blade to be moved in lateral directions to cut the PT tendon tail.

17. A post-tension (PT) tendon tail cutting tool, comprising:
a blade housing, wherein the blade housing comprises a rotary blade and an opening;
a blade housing connector, wherein the blade housing connector comprises a second opening, wherein the blade housing is affixed to the blade housing connector; and
a motor, wherein when the motor rotates the blade housing connector, the rotary blade rotates to cut a PT tendon tail inside a stressing pocket, wherein the blade housing is sized to fit within the stressing pocket, wherein the opening of the blade housing is sized to allow the PT tendon tail to be extended through the blade housing, wherein the second opening of the blade housing connector is sized to allow the PT tendon tail to be extended through the blade housing connector.

18. The PT tendon tail cutting tool of claim 17, wherein the blade housing further comprises a bottom housing component and a top housing component,
wherein the bottom housing component comprises a first side and a second side, wherein the first side and the second side are parallel to each other, wherein the opening is located on the first side,
wherein the rotary blade is removably affixed to the second side, wherein the rotary blade is sized to allow the PT tendon tail to be extended through the bottom housing component, and
wherein the top housing component is affixed to the bottom housing component to keep the rotary blade affixed to the second side, wherein the top housing component is sized to allow the PT tendon tail to be extended through the top housing component.

19. The PT tendon tail cutting tool of claim 17,
wherein the blade housing further comprises a slot,
wherein the rotary blade comprises a protrusion, and
wherein the rotary blade is removably affixed to the blade housing by affixing the protrusion to the slot.

20. The PT tendon tail cutting tool of claim 17, wherein the blade housing further comprises a bottom housing component,
wherein the bottom housing component comprises a first side and a second side, wherein the first side and the second side are parallel to each other, wherein the opening is located on the first side, and
wherein the rotary blade is non-removably affixed to the second side, wherein the rotary blade is sized to allow the PT tendon tail to be extended through the bottom housing component.
